(19) United States
(12) Patent Application Publication
(10) Pub. No.: US 2004/0064383 A1
(43) Pub. Date: Apr. 1, 2004

(54) Method of generating and communicating trouble reports

(76) Inventors: Jennifer Gilger, Torrance, CA (US); Sandi Petkus, Torrance, CA (US); Steve Verdes, Dayton, OH (US); Richard G. Chesnut, Marysville, OH (US); Chester A. Stanley, Marysville, OH (US); Corey Brock, Powell, OH (US); Preston H. Spahr III, Delaware, OH (US)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/260,520

(22) Filed: Oct. 1, 2002

(51) Int. Cl. G06F 17/60

(52) U.S. Cl. 705/28

(57) ABSTRACT

A computer based method for communicating problems with parts shipments to a customer includes detecting a problem with the shipment, creating a trouble report with a notification to the customer, approving the trouble report with notification to the supplier, entering a proposed solution by the supplier with notification to the customer, and approval or disapproval of the solution by the customer.

### BACKGROUND OF THE INVENTION

1. Field of the Invention

The method of this invention is a method for generating and communicating trouble reports regarding shipments of parts from a parts supplier to a purchaser. More specifically, the instant method is directed to a computer based method for directly communicating to the parts supplier problems with shipments of parts.

In a parts distribution system, where parts, such as auto parts, are shipped from a supplier to a purchaser to be warehoused for distribution to dealers, often the parts are shipped to a parts packaging center before being shipped to a hub of the purchaser or directly to the parts warehouses of the purchaser. In such a situation, parts, which are manufactured by the supplier, are shipped to the packaging center for packaging. It is also possible that parts may be shipped directly to a hub or to parts warehouses of the purchaser. For example, in the auto industry, parts are often produced and shipped without being packaged. Oil filters, for example, are shipped to the packaging center in bulk and the packaging center then puts each oil filter into an individual box. Then the individual boxes are shipped in crates or individually to the purchaser. The purchaser may have one or a plurality of warehouses in which to stock the parts before selling them to dealers. Often the purchaser has a centralized hub which receives shipments from the supplier or packaging center and then reships the parts to individual warehouses.

Thus, in the chain of parts distribution described above, the shipments from the supplier are first received by the packaging center and inspected at that time. If there are any problems with the shipment, such as a deficiency in the number of parts actually shipped, the packaging center will detect this problem and usually notify the purchaser. In the past, such a problem would be communicated to the purchaser in many different ways. For example, this information may have been communicated by facsimile, or other commonly known communication means. With such communications taking place between the supplier, the packaging center, and the purchaser, much paper was generated.

Furthermore, not only did the purchaser, and eventually the supplier, need to be notified, but there had to be some mechanism or system for correcting the root problem that led up to the problem noted with the shipment in the first place. There would be communications between the purchaser and the supplier as to how to solve these problems. Thus, more paper was generated. For example if the packaging center receives a shipment of 47 oil filters, when the order was for 50 oil filters, the packaging center would send out a notification to the purchaser of the deficiency. The purchaser and the supplier would then communicate back and forth regarding how to deal with the deficiency and then how to solve the root problem that caused the deficiency, such as an insufficiently trained packing worker at the supplier's shipping location. The process described above not only generates a great deal of paper, but also is very time consuming.

### SUMMARY OF THE INVENTION

The method in accordance with the instant invention is intended to solve the problems described above, as well as many other problems associated with the chain of parts distribution from the supplier to the purchaser. It is advantageous to employ a shared database in order to provide a computer based method to provide for efficient and secure communication between the supplier and the purchaser. This is particularly true when a purchaser is dealing with a large number of suppliers. With a shared database, both the supplier and the purchaser may access a single document and input specific information on that document in order to communicate the problem and problem solution with one another. The packaging center, either directly or through a trouble report coordinator, may access the same database.

The ability to access the same document (shared document) on the shared database and to share information by adding information to that same document enables the supplier and the purchaser to quickly and efficiently exchange information. This is all accomplished in a substantially paperless environment. Furthermore, when one of the parties (supplier or purchaser or packaging center (directly or through a trouble report coordinator)) modifies the shared document, a note (preferably an E-mail note) is automatically sent to the concerned party who is thus notified that new information is in the shared document that should be read. Accordingly, such a shared document on the shared database is then easily accessed by the necessary party.

While many types of databases may be used for the shared document, it is preferable that the shared document be stored on an internet accessible web site so that it is easily accessible by any of the concerned parties. For example, it is preferable that the shared document, such as a trouble report be stored on a secure web site of the purchaser. While it is possible to store the shared document at another location, the web site of the purchaser is preferred. If the shared document is stored on the web site of the purchaser, it allows the purchaser to have maximum control over it. Of course, it is important for there to be sufficient security on the web site itself. Because it is on the web site it is easy for all of the parties to access it. A security feature, such as a security code would be preferred in order to access the web site and the shared document. Accordingly, the parties may communicate important information with one another regarding the problems of parts shipments and solutions to such problems quickly and efficiently in a secure environment.

In accordance with the instant method, a computer based method for communicating problems when parts are shipped from a supplier to a packaging center and then ultimately to a purchaser, includes

detecting a problem in an order received at a packaging center from a supplier;

sending information regarding the problem to a trouble report coordinator;

creating a trouble report, by the trouble report coordinator, on a shared data base to which said supplier, said trouble report coordinator and said purchaser share access;

upon the creation of the trouble report, automatically sending a note to a designated supply specialist of the purchaser that a trouble report has been created;

accessing the trouble report in the shared data base by the supply specialist;

indicating approval or disapproval of the trouble report on the trouble report itself on the shared data base, by the supply specialist;

upon approval of the trouble report by the supply specialist, automatically sending a note to the supplier that a trouble report has been created that relates to the supplier;

accessing the approved trouble report in the shared data base by the supplier;

entering a proposed solution on the trouble report in the shared data base by the supplier;

upon entering a proposed solution on the trouble report, automatically sending a note to the supply specialist indicating that a proposed solution has been entered into the trouble report;

accessing the trouble report with the proposed solution, by the supply specialist, on the shared database;

approving or disapproving the solution proposed by the supplier in the trouble report; and

notifying the supplier if the proposed solution in the trouble report has been disapproved.

Further, the instant method may include activating an alarm condition, or adding the supplier to a past due list on the data base, if the supplier does not enter a proposed solution within a predetermined period of time from the sending of a note to the supplier that a trouble report had been created. Additionally, the instant method may include extending the predetermined period of time upon a request from a supplier and an approval by the purchaser.

The instant method also enables the packaging center to create the trouble report directly by accessing the secure web site and creating a trouble report directly. Additionally, any of the parties may attach an image to the shared document (trouble report) in order to assist the other parties in understanding the problem.

### BRIEF DESCRIPTION OF THE DRAWINGS

FIG. 1 is a block diagram illustrating an overall arrangement of connections for providing communications between the supplier, the packaging center and the purchaser;

FIG. 2 is a flow chart illustrating the flow of communications between the supplier, the packaging center, and the purchaser;

FIG. 3 is a flow chart illustrating an alternate flow of communications between the supplier, the packaging center, and the purchaser;

FIG. 4 is also a flow chart illustrating an alternate path of communications after the item A in FIGS. 2, 3 and 5; and

FIG. 5 is a flow chart illustrating an alternate flow of communications, involving a parts warehouse.

### DETAILED DESCRIPTION OF THE INVENTION

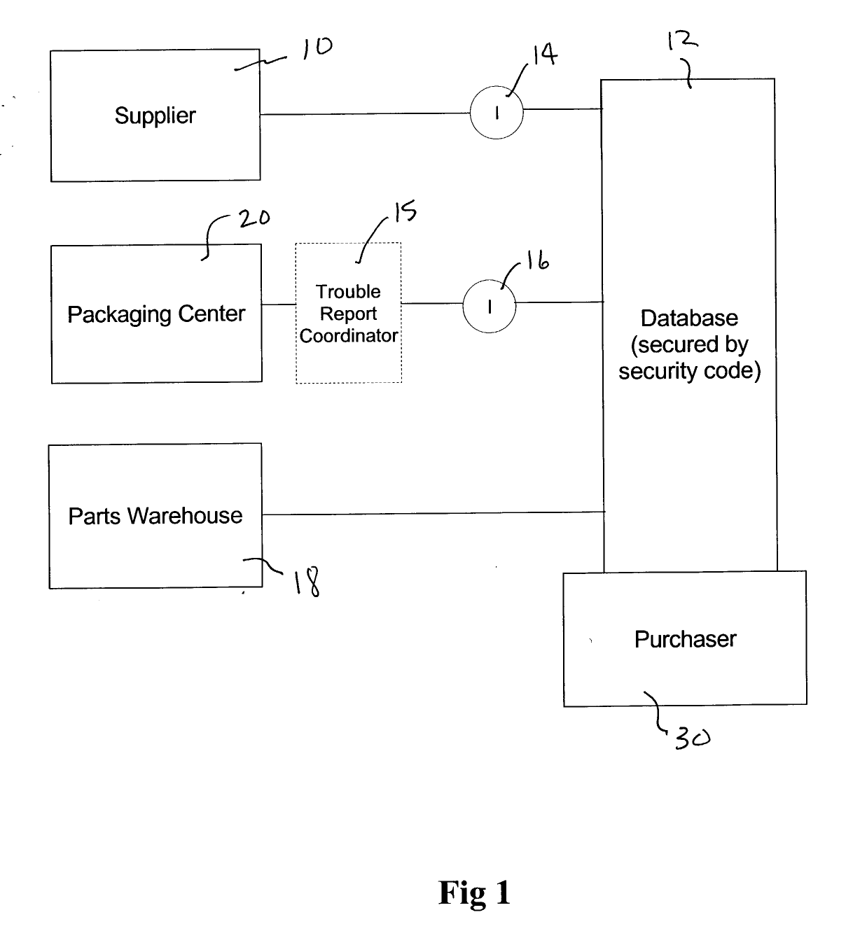

FIG. 1 illustrates an overall arrangement of connections for providing communications between the supplier, the packaging center (also a parts warehouse) and the purchaser in accordance with the instant method. For example, in the context of the automotive industry, a parts supplier 10 will ship auto parts to a purchaser 30 (such as an automobile manufacturer) in order for the auto parts to be warehoused for eventual sale to auto dealers. Often, such auto parts are not shipped directly to the purchaser 30, but instead are first shipped to a packaging center 20, in which the parts are packaged before being shipped to the purchaser 30. Since, often the supplier simply ships its products in bulk, they must be packaged before being shipped on to the purchaser. It is then common for the packaging center to ship the parts directly to warehouses of the purchaser or to a centralized hub of the purchaser for eventual distribution to warehouses of the purchaser. It is natural, since the parts shipments are sent to the packaging center first, that the packaging center conduct the first inspection of the parts shipped. Accordingly, the packaging center will first note that there is a problem with the shipment, such as too few parts, too many parts, etc. This information will then be forwarded to the purchaser and eventually to the supplier for resolution. Also, sometimes parts are shipped directly to a parts warehouse, eliminating the packaging center.

In FIG. 1, supplier 10 is linked to data base 12 by way of internet link 14. It is possible to connect with data base 12 by other ways, such as by modem or direct connection, but the internet is the easiest way to connect. Likewise, packaging center 20 may be linked to the data base 12 by way of internet link 16. There may or may not be another link between packaging center 20 and the data base 12, such as a trouble report coordinator 15, illustrated in broken lines. Data base 12 is part of the purchaser's own data base, in which case the purchaser 30 may access data base 12 directly without using an external link. Furthermore, a parts warehouse 18 (owned by the purchaser) will also be directly connected to the purchaser's data base.

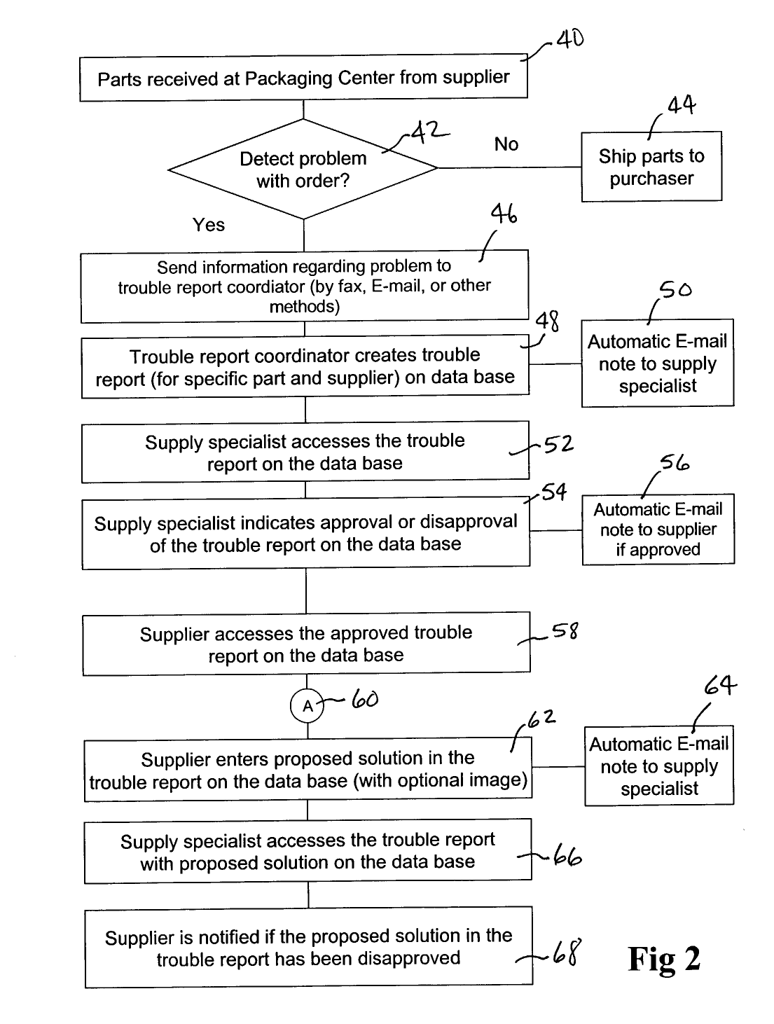

FIG. 2 is a flow chart illustrating the flow of communications between the supplier, the packaging center and the purchaser. Step 40 shows that the parts shipped from the supplier are received at the packaging center. Step 42 is a decision block in which it is determined whether or not there is a problem with the order (or shipment). In other words, were too few or too many parts or pieces delivered? Were some damaged in shipping? If there is no problem with the shipment, then the parts are packaged and shipped on to the purchaser, as indicated at step 44.

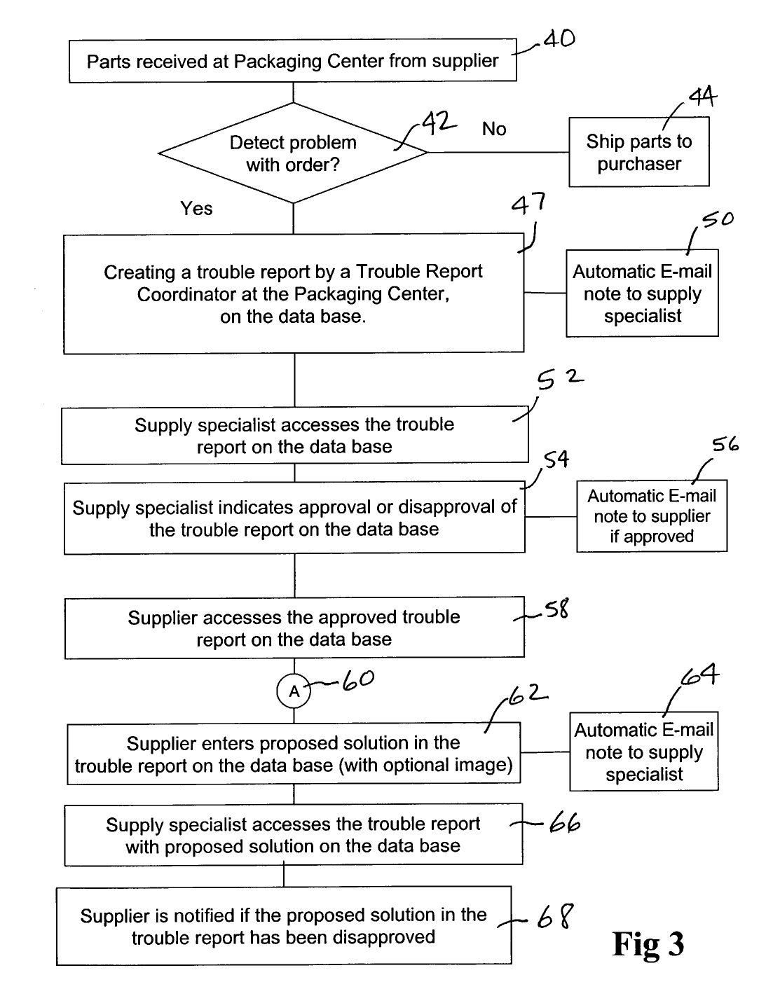

If there is a problem with the shipment, then step 46 indicates that information regarding the problem is sent to a trouble report coordinator. The trouble report coordinator may be located on the premises of the packaging center or may be located elsewhere, such as at one of the purchaser's locations. If the trouble report coordinator is located at the location of the packaging center, then a trouble report may be created directly (as at step 47 in FIG. 3). On the other hand, if the trouble report coordinator is found at a different location from the packaging center, personnel at the packaging center that detected the problem in the order or shipment must them communicate with the trouble report coordinator. Often this is accomplished by fax, E-mail or any other sort of conventional communication.

Once the trouble report coordinator has knowledge of the problem, he or she then creates a trouble report on the data base as at step 48. Upon accessing the data base, either directly, by internet connection or by other conventional means, a trouble report may be created on the data base. For example, it may be created on a program such as Lotus Notes®. Once the trouble report has been created, an E-mail note is automatically sent to the purchaser (step 50) to indicate to the purchaser that the trouble report has been created for a specific part and supplier.

Step 52 indicates that a supply specialist at the purchaser accesses the trouble report on the data base. Upon review of the trouble report, the supply specialist approves or disapproves the trouble report and so indicates on the document in the data base (Step 54). If the trouble report is not approved, then a notification, such as an E-mail, is sent back to originator. If the supply specialist approves the trouble report, it is so indicated on the trouble report, and an E-mail note will be sent to the supplier (Step 56). The E-mail note indicates to the supplier that a trouble report has been created and should be reviewed by the supplier.

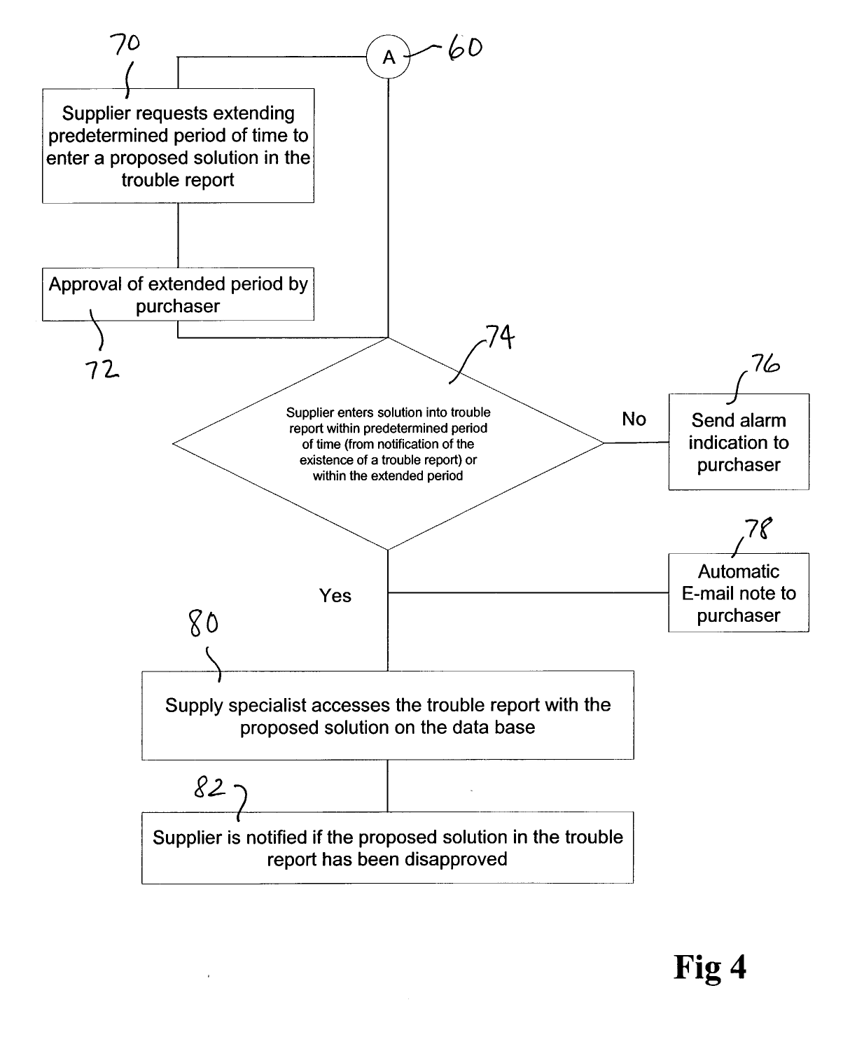

Step 58 indicates that the supplier accesses the approved trouble report on the data base. The supplier will find out from the trouble report what the problem was with the order. There is a predetermined amount of time for the supplier to respond to the trouble report. This predetermined period of time for response will be discussed below in greater detail with regard to FIG. 4. Upon investigation by the supplier, the supplier will hopefully gain an understanding of the problem and accordingly devise a solution of how to fix the problem. In step 62 the supplier enters a proposed solution in the trouble report in the data base. Optionally, an image may be attached to the trouble report with the proposed solution. The supplier will typically set forth the problem as he recognizes it, including a deeper root problem if there is one. The supplier will also indicate what he believes is a short term solution and a long term solution. It should be noted that reference numeral 60 refers to item A in the flow chart of FIG. 2. Item A indicates a location, at which an alternate flow or path of communications may take place, as further discussed below with regard to FIG. 4.

Upon the entering of a proposed solution by the supplier at step 62, an automatic E-mail is then sent to the supply specialist at step 64. This E-mail notifies the supply specialist that the supplier has entered a proposed solution and that it is available for review by the supply specialist. At step 66, the supply specialist accesses the trouble report in the data base. The supply specialist can now substantively review the proposed solution on the trouble report and approve or disapprove the proposed solution. At step 68, the supplier is then notified that the proposed solution has been disapproved. If disapproved, the supplier may revise his solution and submit it again. If approved, there is approval and, thus, there is no need to notify the supplier.

FIG. 3 is a flow chart illustrating an alternate flow of communications between the supplier, the packaging center and the purchaser. While similar to FIG. 2, step 47 of FIG. 3 replaces steps 46 and 48 of FIG. 2. In step 47, the trouble report coordinator, or someone of similar nature, is on site at the packaging center and creates the trouble report directly without requiring an additional step of sending information, about a problem with an order, from the packaging center to an outside trouble report coordinator. Otherwise, the remainder of the communications flow is similar, and similar steps are indicated by similar step numbers.

FIG. 4 is also a flow chart illustrating an alternate path of communications after item A (reference numeral 60) in FIGS. 2 and 3. From item A in FIG. 2 or 3, the alternate flow of communications in FIG. 4 replaces the flow of communications following item A in both FIGS. 2 and 3. Thus, after step 58 in FIG. 2 or 3, in which the supplier accesses the approved trouble report on the data base, the procedure then would go to step 74. Step 74 determines whether or not the supplier has entered a proposed solution into the trouble report within a predetermined period of time from the first notification that a trouble report had been created. Such a predetermined period of time might be 4 or 5 days, or even a week. However, any appropriate time period could be used. If the supplier does not enter a solution within the predetermined period, step 76 adds that supplier to a list of past due suppliers in the data base, which may be Lotus Notes®.

If the supplier enters the solution within the predetermined period of time, Then as with the flow of communications in FIGS. 2, 3 and 5, an automatic E-mail note is sent to the purchaser at step 78 indicating that the proposed solution is entered into the trouble report. Accordingly, steps 80 and 82 indicate that the supply specialist accesses the trouble report with the proposed solution, and notifies the supplier that the proposed solution has been disapproved. If approved, there is no special notification given to the supplier and he proceeds with his implementation of the solution.

If, before the supplier enters the proposed solution, he determines that he needs additional time (more than the predetermined period of time) in which to provide a solution to the order problem, he may request an extension of time on the trouble report. On the trouble report, the supplier may request an extension of time to enter his proposed solution as at step 70. The supplier may also request a specific extension (or extended period) and may also indicate the reason for the request for the extended period. Step 72 indicates if there is approval by the purchaser of the request for extended period for providing a proposed solution. If there is an approval, the procedure then flows to step 74 described above. Step 74 also determines whether the supplier has entered his proposed solution into the trouble report, within the extended period, if the extended period has been approved.

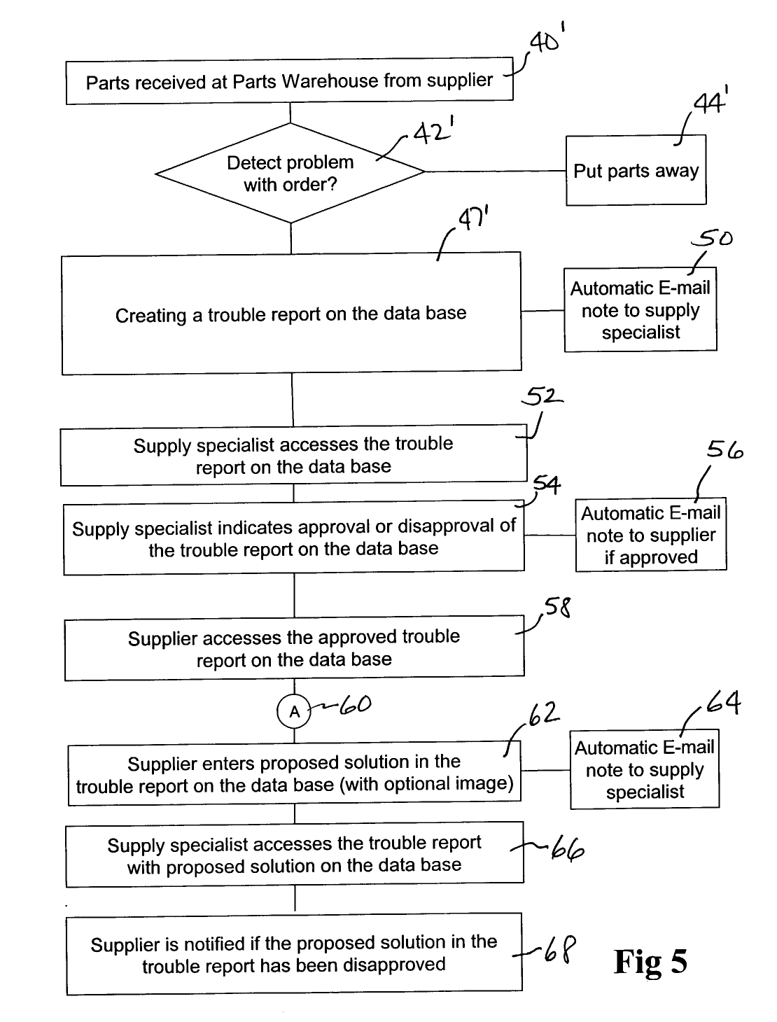

FIG. 5 is a flow chart illustrating an alternate flow of communications involving a parts warehouse. In FIG. 5, a parts warehouse receives parts directly from a supplier. Step 40′ illustrates that parts are received directly from a supplier. In step 42′ it is determined whether or not there is a problem with the order. If there is no problem then at step 44′ the parts are put away in the warehouse. If there is a problem with the order, then, since the warehouse is directly connected to the data base, the warehouse directly creates a trouble report on the data base as illustrated at step 47′. An automatic E-mail is then sent to the supply specialist (step 50). The remaining steps 52-68 are the same as described above with reference to FIGS. 2 and 3.

I claim:

1. A computer based method for communicating problems when parts are shipped from a supplier to a packaging center and then ultimately to a purchaser, said method comprising the steps of:
detecting a problem in an order received at a packaging center from a supplier;
sending information regarding the problem to a trouble report coordinator;
creating a trouble report, by the trouble report coordinator, on a shared data base to which said supplier, said trouble report coordinator and said purchaser share access;
upon the creation of the trouble report, automatically sending a note to a designated supply specialist of the purchaser that a trouble report has been created;
accessing the trouble report in the shared data base by the supply specialist;
indicating approval or disapproval of the trouble report on the trouble report itself on the shared data base, by the supply specialist;
upon approval of the trouble report by the supply specialist, automatically sending a note to the supplier that a trouble report has been created that relates to the supplier;
accessing the approved trouble report in the shared data base by the supplier;
entering a proposed solution on the trouble report in the shared data base by the supplier;
upon entering a proposed solution in the trouble report, automatically sending a note to the supply specialist indicating that a proposed solution has been entered into the trouble report;
accessing the trouble report with the proposed solution, by the supply specialist, on the shared database; and
approving or disapproving the solution proposed by the supplier in the trouble report.

2. The method of claim 1, wherein said database is accessible by the internet.

3. The method of claim 1, where said database requires a security code in order to be accessed.

4. The method of claim 1, wherein said notes are created in E-mail.

5. The method of claim 1, wherein said step of sending information comprises faxing the information to the trouble report coordinator.

6. The method of claim 1, further comprising adding the supplier to a past due list on the data base if the supplier does not enter a proposed solution within a predetermined period of time from the sending of the note to the supplier that a trouble report has been created.

7. The method of claim 1, further comprising the step of extending the predetermined period of time upon a request from the supplier.

8. A computer based method for communicating problems when parts are shipped from a supplier to a packaging center and then ultimately to a purchaser, said method comprising the steps of:
detecting a problem in an order received at a packaging center from a supplier;
creating a trouble report by a trouble report coordinator at the packaging center, on a shared data base to which said supplier, said trouble report coordinator and said purchaser share access;
upon the creation of the trouble report, automatically sending a note to a designated supply specialist of the purchaser that a trouble report has been created;
accessing the trouble report in the shared data base by the supply specialist;
indicating approval or disapproval of the trouble report on the trouble report itself on the shared data base, by the supply specialist;
upon approval of the trouble report by the supply specialist, automatically sending a note to the supplier that a trouble report has been created that relates to the supplier;
accessing the approved trouble report in the shared data base by the supplier;
entering a proposed solution in the trouble report in the shared data base by the supplier;
upon entering a proposed solution in the trouble report, automatically sending a note to the supply specialist indicating that a proposed solution has been entered into the trouble report;
accessing the trouble report with the proposed solution, by the supply specialist, on the shared database, with the proposed solution; and
approving or disapproving the solution proposed by the supplier in the trouble report.

9. The method of claim 8, wherein said database is accessible by the internet.

10. The method of claim 8, where said database requires a security code in order to be accessed.

11. The method of claim 8, wherein said notes are created in E-mail.

12. The method of claim 8, further comprising the step of notifying the supplier if the proposed solution in the trouble report has been disapproved.

13. The method of claim 8, further comprising adding the supplier to a past due list on the data base if the supplier does not enter a proposed solution within a predetermined period of time from the sending of the note to the supplier that a trouble report has been created.

14. The method of claim 8, further comprising the step of extending the predetermined period of time upon a request from the supplier.

15. A computer based method for communicating problems when parts are shipped from a supplier to a packaging center and then ultimately to a purchaser, said method comprising the steps of:
detecting a problem in an order received at a packaging center from a supplier;
sending information regarding the problem to a trouble report coordinator;
creating a trouble report, by the trouble report coordinator, on a secure website accessible only by the trouble report coordinator, the supplier and the purchaser;
upon the creation of the trouble report, automatically sending an E-mail note to a designated supply specialist of the purchaser indicating that a trouble report has been created;
accessing the trouble report on the secure website by the supply specialist;
indicating approval on the trouble report by the supply specialist;
upon approval of the trouble report by the supply specialist, automatically sending an E-mail note to the supplier indicating that a trouble report has been created for that supplier;
accessing the approved trouble report on the secure website by the supplier;
entering a proposed solution on the trouble report in the shared data base by the supplier;
upon entering a proposed solution, automatically sending an E-mail note to the supply specialist indicating that a proposed solution has been entered into the trouble report;
accessing the trouble report, on the secure website by the supply specialist for review of the proposed solution; and
approving or disapproving the solution proposed by the supplier in the trouble report.

16. The method of claim 15, wherein said step of sending information comprises faxing the information to the trouble report coordinator.

17. The method of claim 15, wherein said step of sending information comprises electronically sending the information to the trouble coordinator.

18. The method of claim 15, further comprising adding the supplier to a past due list on the data base if the supplier does not enter a proposed solution within a predetermined period of time from the sending of the note to the supplier that a trouble report has been created.

19. The method of claim 15, further comprising the step of extending the predetermined period of time upon a request from the supplier.

20. A computer based method for communicating problems when parts are shipped from a supplier to a parts warehouse of the purchaser, said method comprising the steps of:
detecting a problem in an order received at a parts warehouse from a supplier;
creating a trouble report on a secure website by the parts warehouse;
upon the creation of the trouble report, automatically sending an E-mail note to a designated supply specialist of the purchaser indicating that a trouble report has been created;
accessing the trouble report on the secure website by the supply specialist;
indicating approval on the trouble report by the supply specialist;
upon approval of the trouble report by the supply specialist, automatically sending an Email note to the supplier indicating that a trouble report has been created for that supplier;
accessing the approved trouble report on the secure website by the supplier;
entering a proposed solution on the trouble report in the shared dated base by the supplier;
upon entering a proposed solution, automatically sending an E-mail note to the supply specialist indicating that a proposed solution has been entered into the trouble report;
accessing the trouble report, on the secure website by the supply specialist for review of the proposed solution; and
approving or disapproving the solution proposed by the supplier in the trouble report.

21. The method of claim 20, further comprising adding the supplier to a past due list on the data base if the supplier does not enter a proposed solution within a predetermined period of time from the sending of the E-mail note to the supplier that a trouble report has been created.

22. The method of claim 21, further comprising the step of extending the predetermined period of time upon a request from the supplier.

23. The method of one of claims 1, 8, 15 or 20, wherein the step of entering a proposed solution by the supplier includes attaching one or more images to the trouble report.

24. The method of one of claims 1, 15 or 20, further comprising the step of notifying the supplier if the proposed solution in the trouble report has been disapproved.
